(19) United States
(12) Patent Application Publication
(10) Pub. No.: US 2005/0233108 A1
(43) Pub. Date: Oct. 20, 2005

(54) Cleaning cloth

(76) Inventor: Pamela Kurt, Hillsborough, NJ (US)

Correspondence Address: John G. Gilfillan, III, Esq.;c/o Carella, Byrne, Bain, Gilfillan, Cecchi,, Stewart & Olstein, 5 Becker Farm Road, Roseland, NJ, 07068, US

(21) Appl. No.: 10/797,435

(22) Filed: Mar. 10, 2004

(51) Int. Cl. B32B 5/00

(52) U.S. Cl. 428/98

(57) ABSTRACT

A skin care device is provided for cleaning of a person's body which comprises a knitted cloth of a plurality of synthetic spun ply yarn strands, preferably acrylic spun ply yarn strands. The plurality of synthetic spun ply yarn strands include twisted synthetic single yarn threads of synthetic fiber. The preferred range of twists for the synthetic single yarn is 8.85 to 9.39 twists per inch, and the preferred range of twists for the synthetic spun ply yarn strands is about 6.0 twists per inch to 6.39 twists per inch. The cloth is stitched using the plurality of synthetic spun ply yarn strands. The cloth defines a plurality of edges which are preferably finished by first being marrowed and then crocheted.

### BACKGROUND OF THE INVENTION

1. Field of the Invention

This invention relates to cleaning cloths which may be used alone or with hand held implements for personal cleaning, and more particularly, to a cloth of knitted synthetic yarn for use on a person's body.

2. Description of Related Art

Known personal care devices include devices for skin care during washing of the user's body and which may utilize specific fabrics for desired uses. For example, synthetic sponges, cotton wash cloths, and abrasive material may be used to cosmetically peel the skin. However, sponges can be difficult to handle when washing. Also, sponges can lack durability, lose their resiliency, pull apart, as well as, be difficult to clean. Additionally, synthetic sponges and cotton washcloths may require drying time which creates an environment for bacteria to grow.

An example of one device for cosmetically peeling the skin is a wash cloth which includes fabric consisting of synthetic fibers or silk fibers. A suitable yarn made for this use may have 2,000 to 2,400 twists per meter to provide the desired peeling effect on the skin.

Another known device comprises a composite textile fabric including a first or inner fabric layer made of synthetic yarn material, and a second or outer fabric layer made of a moisture-absorbent yarn material, or a synthetic yarn which has been rendered hydrophilic, or a combination thereof. The textile fabric fibers are treated to have anti-microbial properties and are blended exclusively in the yarn of the outer fabric layer. The fabric so treated moves moisture away from the skin and can move moisture through a garment made with the composite fabric.

Another known personal cleaning device comprises a tubular piece of hydrophobic diamond-mesh scrim or loosely woven fabric, which is stretched to expand the diamond mesh. The scrim is heat set in an expanded and pleated condition to form a substantially rectangular resilient batt.

Another known fabric for use with bath, kitchen and apparel products comprises a terry fabric formed of ground yarns interlaced with terry yarns to form terry loops. The fabric may be mercerized during finishing to enhance softening, and a wetting agent may also be applied to increase absorbency.

Another article for cleansing the skin or a person's hair includes a water insoluble substrate and lathering surfactant. In use, the article is wetted with water and rubbed against the skin or hair.

Another device utilizing a specialized fabric for skin care is a patient underpad. The underpad includes a re-usable pad having a top section of porous terry or circular knit fabric with a polyester stabilizing yarn.

Patents which may reflect the state of the prior art include, U.S. Pat. No. 5,439,487 to Stanitzok which discloses a device for cosmetically peeling the skin which includes fabric consisting of synthetic fibers or silk fibers. The yarn is twisted, and in one embodiment the yarn is twisted between 2,000 to 2,400 twists per meter. The yarn thereby provides the desired peeling effect on the skin.

U.S. Pat. No. 6,602,811 to Rock et al. discloses a composite textile fabric including a first or inner fabric layer made of synthetic yarn material. A second or outer fabric layer is made of a moisture-absorbent yarn material, or a synthetic yarn which has been rendered hydrophilic, or a combination thereof. The textile fabric fibers are treated to have anti-microbial properties and are blended exclusively in the yarn of the outer fabric layer. The fabric moves moisture away from the skin and may move moisture through a garment made with the composite fabric.

U.S. Pat. No. 5,630,245 to Tuthill et al. discloses a personal cleaning device comprising a tubular piece of hydrophobic diamond-mesh scrim or loosely woven fabric. The fabric is stretched to expand the diamond mesh. The scrim is heat set in an expanded and pleated condition to form a substantially rectangular resilient batt.

U.S. Pat. No. 5,667,865 to Jackson et al. discloses a terry fabric where terry yarns are interlaced with ground yarns to form terry loops. The fabric may be mercerized during finishing to soften the fabric, and a wetting agent may also be applied to increase absorbency.

U.S. Pat. No. 6,495,151 to McAtee et al. discloses an article for cleansing the skin or hair which includes a water insoluble substrate and lathering surfactant releasably associated with the substrate. In another embodiment, the article may include a conditioning component. In use, the article is wetted with water and then rubbed against the skin or hair.

U.S. Pat. No. 6,028,241 to Armstead discloses a patient underpad having a top section of porous terry or circular knit fabric with a polyester stabilizing yarn. The top section is serged, stitched, or bonded to a bottom section that includes PVC vinyl water barrier bonded to a polyester knit cloth.

U.S. Pat. No. 6,253,582 to Driggars discloses a fabric knitted from yarn formed from high-tenacity, staple synthetic fiber having a tenacity value of greater then about 4 grams/denier and preferably about 6 grams/denier. In a preferred embodiment, the high-tenacity, staple synthetic fiber is selected from the group consisting of air jet spun polyester; nylon; acrylic; and polypropylene.

U.S. Pat. No. 6,048,410 to Honeycutt discloses garments, linens, drapes, towels and other articles as woven, non-woven, knitted or otherwise formed fabric of thermoplastic polyvinyl alcohol polymer fiber. The fiber is water soluble only at temperatures above approximately 37 degrees C.

US Publication No. 2002/0059683 to Sakamoto et al. discloses a pre-dyeing treatment process for textile products, such as, yarns, woven fabrics, knit fabrics, and which include highly crosslinked polyacrylic fibers. The treatment process includes a pretreatment step of immersing the textile product into an acidic solution and treating it at a high temperature and an elevated pressure.

U.S. Pat. No. 5,085,914 to Perdelwitz, Jr. et al. discloses a towel with a thermobonded core of thermoplastic and other fibers. The towel has at least one cover sheet which is preferably formed with apertures and has a limited stretchability.

The known devices have shortcomings and undesirable attributes including undesirably long drying times which leave an opportunity for bacteria to grow. After only several uses, an undesirable odor can develop from the existing devices. Further, known devices do not achieve desired lathering when soaping the device. The fabrics used in known devices may also be uncomfortably rough on the skin when used, as well as, difficult to handle when wet.

It is therefore an object of the present invention to provide a fabric device for skin care which dries rapidly thus reducing mildew and bacteria. There is also a need for a skin care device which is soft to the touch, and resilient in retaining its shape and texture. Further, there is a need for a skin care device which dries quickly, lathers well, and is reusable. Still further there is a need for a skin care device which can be used alone or combined with other personal care devices to reflect personal preferences in body care, or for convenience of use in personal care.

### SUMMARY OF THE INVENTION

According to an aspect of the present invention, a skin care device is provided for personal cleaning of a person's body comprising a knitted cloth of synthetic fabric. The synthetic fabric comprises a plurality of synthetic ply yarn strands which are twisted in the range of about 6.0 twists per inch to 6.39 twists per inch. The plurality of synthetic ply yarn strands include a plurality of synthetic single yarn threads each being twisted in the range of about 8.85 twists per inch to 9.39 twists per inch. The plurality of synthetic single yarn threads are comprised of a plurality of spun synthetic elongated fibers, the plurality of spun synthetic elongated fibers have a diameter in the range of about 2.8 dTex to 3.4 dTex. The knitted cloth includes stitching being comprised of the plurality of synthetic ply yarn strands, the stitching is about 8 to 12 stitches per inch along the length of the cloth and about 3 to 7 stitches per inch along the width of the cloth. The knitted cloth defines a plurality of edges which are finished using a stitching arrangement of a yarn material to bind the edges of the cloth.

In a further aspect the plurality of synthetic ply yarn strands are substantially acrylic.

In a further aspect the fiber size of the plurality of spun synthetic elongated fibers is about 3.1 dTex.

In a further aspect the plurality of synthetic single yarn threads are twisted about 9.12 twists per inch.

In a further aspect the plurality of synthetic ply yarn strands are twisted about 6.20 twists per inch.

In a further aspect the stitching is about 10 stitches per inch along the length of the cloth and 5 stitches per inch along the width of the cloth.

In a further aspect the plurality of synthetic ply yarn strands comprise two synthetic single yarn threads.

In a further aspect the yarn material may be substantially acrylic ply yarn, or may be a different yarn material than the acrylic ply yarn.

In a further aspect the stitching arrangement of the knitted cloth includes marrowing and crocheting.

In a further aspect the stitching arrangement of the knitted cloth includes a stitch pattern having areas of raised stitching.

In a further aspect the plurality of acrylic ply yarn is high bulk acrylic ply yarn.

In a further aspect a portion of the edges of the knitted cloth are bound to each other to define a cavity and an opening communicating with the cavity, and the cavity and opening are both adapted to accept a person's hand.

In a further aspect the knitted cloth is coupled to a holding device selected from the group consisting essentially of a pad, a brush, and a sponge.

In a further aspect the plurality of synthetic single yarn threads are “Z” twisted and the plurality of synthetic ply yarn strands are “S” twisted.

In another aspect of the present invention a method of manufacturing a skin care device for use on a person's body comprises forming a plurality of elongated synthetic fibers each having a diameter in the range of about 2.8 dTex to 3.4 dTex. The method includes spinning the plurality of elongated synthetic fibers into a plurality of synthetic single yarn threads being twisted from the spinning in the range of about 8.85 twists per inch to 9.39 twists per inch. The method further includes twisting at least two of the plurality of synthetic single yarn threads together to provide a plurality of synthetic ply yarn strands which are twisted in the range of about 6.0 twists per inch to 6.39 twists per inch. Further the method includes knitting the plurality of synthetic ply yarn strands into a cloth having about 10 stitches per inch along a length and 5 stitches per inch along a width of the cloth. Still further, the method includes finishing a plurality of edges defined by the cloth to bind the plurality of edges.

In a further aspect the step of finishing the plurality of edges includes marrowing and crocheting the edges.

In a further aspect the method includes forming the plurality of elongated synthetic fibers from substantially acrylic material.

In a further aspect the method includes the diameter of the plurality of elongated synthetic fibers being about 3.1 dTex, the plurality of synthetic single yarn threads being twisted about 9.12 twists per inch, and the plurality of synthetic ply yarn strands being twisted about 6.20 twists per inch.

### BRIEF DESCRIPTION OF THE DRAWINGS

FIG. 1 is a plan view of a preferred embodiment of the cleaning cloth according to the invention;

FIG. 2 is a plan view of a preferred stitching pattern of the cleaning cloth according to the invention;

FIG. 3 is a photograph of a piece of the cleaning cloth depicting an outer edge of the cloth in different phases of being finished according to an embodiment of the present invention;

FIG. 4 is a plan view of a cloth with an edge being marrowed using a stitch pattern;

FIG. 5 is a plan view of a cloth with an edge marrowed using a different stitch pattern than shown in FIG. 4;

FIG. 6 is a perspective view of a yarn being crocheted on a device;

FIG. 7 is a cross sectional side elevational view of the yarn and the device shown in FIG. 6;

FIG. 8 is a side elevational view of a fiber of a fabric material;

FIG. 9 is a cross sectional view of the fiber shown in FIG. 8;

FIG. 10 is an end view of fibers of fabric material having a “bean shape”;

FIG. 11 is a side view of a single twisted yarn thread of fiber; and

FIG. 12 is a side view of a two ply twisted yarn strand comprising two single twisted yarn threads.

### DETAILED DESCRIPTION OF THE PREFERRED EMBODIMENT(S)

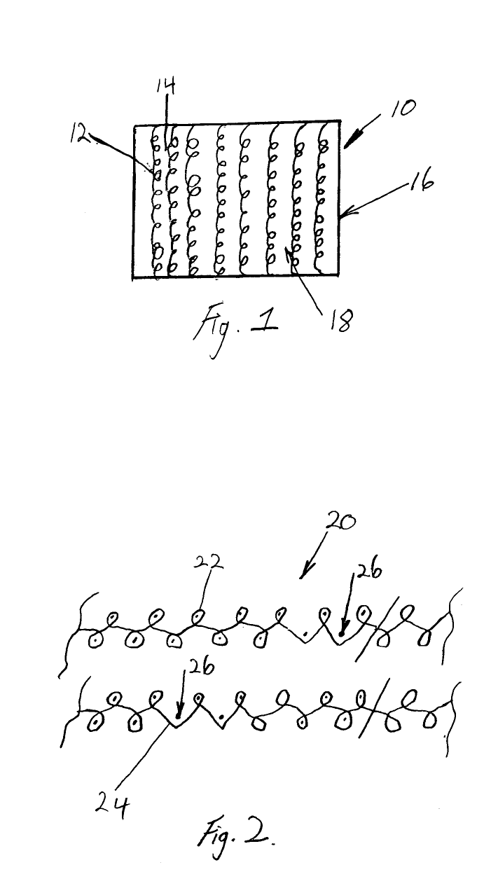

A preferred embodiment of a cleaning cloth 10 according to the invention is shown in FIG. 1-3. The cloth can be fabricated using a conventional flat bed knitting machine. In the preferred embodiment of the cloth 10 a synthetic fabric is used, e.g. an acrylic yarn. Other synthetic fabrics may also be used or a combination of synthetic fabrics. The cloth 10 is knitted not woven.

The cleaning cloth 10 is generally rectangular in shape but may be square, triangular or any desired shape including an irregular shape. The cloth 10 can be made of synthetic spun yarn. The cloth 10 is preferably made of high bulk acrylic spun two ply yarn.

In another embodiment of the cleaning cloth according to the present invention the worsted count is 2/21.31 which signifies two single yarn threads combined (thus having two ends) of 1/21.31 yarn plied together. In still another embodiment of the cleaning cloth the yarn may be a firm-textured, compactly twisted, woolen yarn made from long-staple fibers.

When making a yarn, typically, the longer the fiber the fewer the twists, and the shorter the fiber the more twists. Longer fibers are preferred for the cloth of the present invention because they result in a softer fabric. In the present invention, the combination of the yarn type and size, the fiber type and size, and twisting specifications provides a personal care device, i.e., a cloth having advantages over known devices, such as enhanced lathering, softness, rapid drying, and excellent retention of shape.

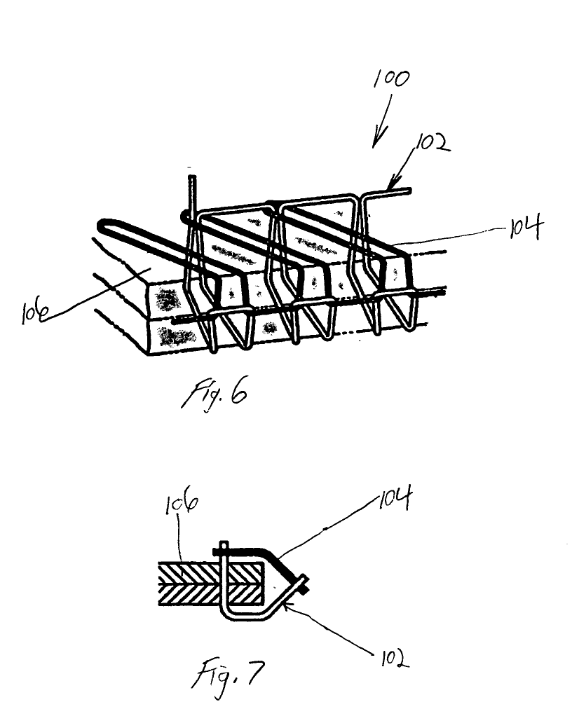

An example of a single fiber 150 is shown in FIG. 8. A single twisted yarn thread 200 made from fibers is shown in FIG. 11. The yarn thread 200 has an end 202 and an elongated body 204 which is twisted about itself to form the single yarn thread from the fibers.

In the preferred embodiment of the present invention, the synthetic fibers are preferably ring spun resulting in twisted yarn threads. A plurality of the single yarn threads can be twisted together to from a ply yarn strand, as shown in FIG. 12.

A two ply yarn strand 220 is shown in FIG. 12 which includes two single yarn threads 222 and 224. The two single yarn threads 222 and 224 have elongated bodies 230 and 232, respectively, and ends 226 and 228. The single yarn threads 222 and 224 are twisted about each other to form the two ply yarn strand 220.

The preferred yarn of the cloth according to the present invention has a single yarn thread twist of about 9.12 twists per inch (about 359.3 twists per Meter). The ply yarn strand (having more than one single yarn thread) preferably has about 6.20 twist per inch (about 244.3 twist per Meter).

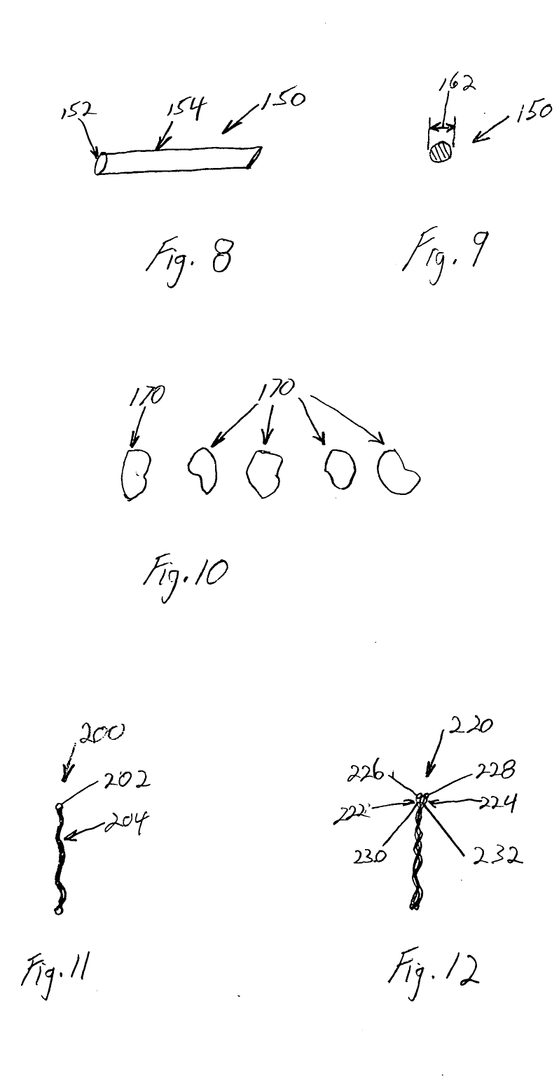

The preferred embodiment of the present invention includes a preferred fiber type of one hundred percent 3 denier semi dull Acrilan® (bean shape) acrylic, having a diameter of about 3.1 dTex. The ends of the bean shaped fiber 170 are shown in FIG. 10. Denier is a unit of fineness for rayon, nylon, and silk fibers, based on a standard mass per length equal to 1 gram per 9,000 meters of yarn.

A fiber 150 is shown in FIGS. 8 and 9 having an end 152 and an elongated body 154. The cross sectional diameter 162 of the fiber 150 may be measured. The preferred range of the cross sectional diameter of the fiber used in the preferred embodiment of the present invention is 2.8 to 3.4 dTex. The most preferred fiber size diameter is 3.1 dTex. One way of referring to the length of the fiber is known in the art as long staple fiber. Preferably, the fiber used in the preferred embodiment of the cloth according to the present invention is a long staple fiber. Techniques for spinning yarn are also known in the art, such as, ring spinning, open end spinning, friction spinning, and air-jet spinning. The preferred spinning technique for the preferred embodiment of the cloth is ring spinning, resulting in ring spun cloth.

Preferably high bulk ring spun Acrylic yarn is used to knit the cloth according to the preferred embodiment of the invention. A preferred acrylic yarn size is 2/24 count (i.e. 2 ply and 24 count) which is two ply yarn strands. The two ply yarn strands are manufactured from two single yarn threads of 1/24 count yarn to make the two ended 24 count, i.e., 2/24 count ply yarn. A preferred range of yarn size is about 22 count to 24 count. A yarn count in generally defined as expressing the mass per unit length or the unit mass of a yarn.

Additionally, the single thread yarn in the preferred embodiment of the cloth of the present invention is twisted within a preferred range of 9.39 to 8.85 twists per inch (348.5 to 370.1 twists per meter). There are different types of twisting known in the art, for example, “S” and “Z” twisting which refer to the direction of the twist. The preferred embodiment of the cloth has a single thread yarn in a “Z” twist of about 9.12 twists per inch (359.3 twists per meter). The single thread yarn is then twisted about another single thread yarn to create a two ply yarn strand. Multiple ply yarn strands may be used, however, the two ply yarn of the cloth according to the present invention is preferred, and is twisted within the preferred range of about 6.0 twists per inch to 6.39 twists per inch (237.0 to 251.6 twists per meter). The preferred embodiment of the cloth has a ply yarn in an “S” twist about 6.20 twists per inch (244.3 twists per meter). Additionally, the preferred embodiment of the cloth has a 1×1 rib and half cardigan pattern with no dots or lines.

The yarn size and fiber size according to the preferred embodiment of the invention provide a cloth having the advantage of being fast drying and permeable to water because the yarn and fiber specifications provide a cloth which has spaces between the fabric. The cloth according to the preferred embodiment of the invention is also resilient because the fabric stretches and resiliently retains its original shape. Twisting the yarn according to the preferred embodiment of the present invention, provides a cloth having the advantages of being soft to the touch and lathering voluminously.

The preferred cloth 10 is provided with a pattern knitted into the cloth fabric 18, an example of which is shown in FIG. 1. The cloth 10 fabric 18 includes raised stitching 12 along the length of the cloth followed by flat stitching 14 alternating the entire width of the cloth.

The yarn stitch 20 of the preferred fabric is shown in FIG. 2. The stitch 20 provides the raised and flat stitching in the cloth and is the preferred design for the cloth. The stitching design includes a loop knit stitch 22, “V” tuck stitch 24, and knitting machine needle positioning represented by dots 26. The preferred stitching pattern shown in FIG. 2 increases absorption and lathering of the cloth. Further, the stitching pattern has the advantage of being more appealing to the touch and lathering better than flat stitching.

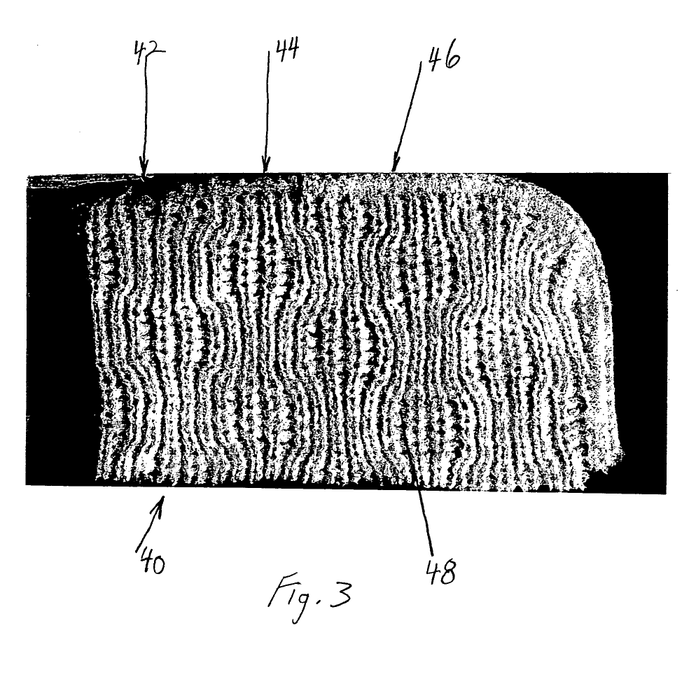

The cloth is finished along the edges 16 preferably using marrowing and crocheting, as shown in FIG. 3 and discussed in more detail below. Other finishing techniques may be used to bind the ends of the yarn around the edges of the cloth to provide a cloth having a finished edge.

During manufacturing, the preferred two ply yarn strands according to the preferred embodiment of the cloth, are used to knit the cloth using a conventional flat bed knitting machine. One such knitting machine, for example, is the CMS 400 electronic flat bed knitting machine set at a preferred setting of 11.6 in a range of 8.5 to 15.0. In a preferred embodiment of manufacturing the cloth, the machine is set to stitch with about seven needles arranged in the machine per inch of cloth (also referred to as a seven gauge machine). The CMS 400 electric flat bed knitting machine can be run, for example, with Jaquard© software which allows programming for controlling the needles.

The preferred fiber for the cloth, as discussed above, is one hundred percent 3 denier semi dull Acrilan® (bean shape) acrylic. In general, a specified yarn is fed through a guide and yarn feeders on the knitting machine. In the preferred embodiment of the cloth, the single yarn threads are high bulk, having a worsted count of 2/21.31, and 9.12 single twists per inch (359.3 twists per Meter). The two ply yarn threads are twisted 6.20 twists per inch (244.3 twists per Meter). The two ply yarn threads are then loaded into each carriage on the machine. The movable carriages are then ready to stitch the product, to a desired stitching pattern, e.g., as shown in FIGS. 2 and 3, by making multiple passes along a programmed surface area.

During this process, nylon strips can preferably be fed into the machine and are knitted throughout the fabric. The nylon serves to separate the yarn during the knitting. Once the knitting procedure is complete, the nylon is removed and is not part of the finished fabric. The cloth is then ready to have it's edges finished.

In general, the yarn is knitted to a preferred closeness or tightness. The preferred range of stitching for the preferred embodiment of the present invention is 8-12 stitches per inch along a length of the cloth, and 3-7 stitches per inch along a width of the cloth. The most preferred stitching count is 10 stitches per inch along a length of the cloth, and 5 stitches per inch along a width of the cloth.

After knitting the cloth, the ends of the cloth are finished using a preferred stitching arrangement to bind the edges during a finishing step. Preferably, the finishing step includes the edges of the cloth first being marrowed, and then crocheted. Both the marrowing and crocheting steps are accomplished using machines known in the art, for example, for crocheting an overlock machine may be used. Marrowing and Crocheting are stitches known in the art which have a specific arrangement of stitching or needlework. The marrowing and crocheting stitching of the ends of the cloth is preferably done using the same material as the cloth, e.g. preferably acrylic spun yarn. However, another fabric material or combinations of fabric materials may also be used.

The preferred edge finishing provides a soft edge and also facilitates the elasticity and resiliency of the cloth which encourages the cloth to retain its shape. More specifically, the cloth according to the present invention provides excellent resiliency after use, as well as, resiliency after washing and drying.

As shown in FIG. 3, the unfinished knit edge 42 of the cloth 40 is first marrow stitched 44. The marrowed edge 44 is then crocheted providing the preferred finished edge 46.

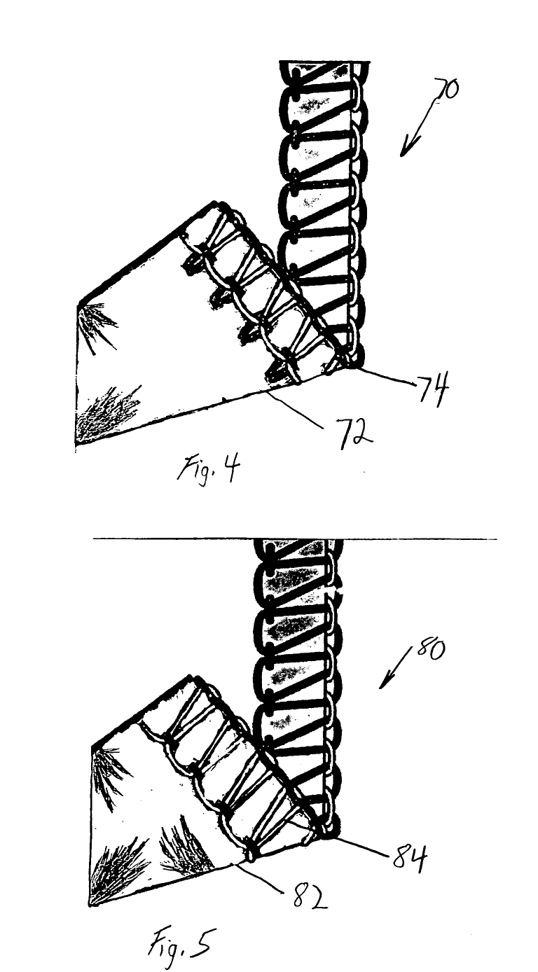

FIG. 4 shows for illustrative purposes a marrow stitch 70 on a fabric 72 where the yarn 74 is stitched through the fabric as shown. FIG. 5 also shows for illustrative purposes a marrow stitch 80 on a fabric 82 where the yarn 84 is stitched through the fabric differently than illustrated in FIG. 4.

For illustrative purposes, referring to FIG. 6, a two-threaded overedge (edge interlooping) arrangement 100 is shown for crocheting yarn. A device 102 attached to a structure 106 holds the thread 104, and the thread is wrapped through the device 102 to crochet. FIG. 7 depicts one part of the device 102 with the yarn 104 stretched thereabout.

The cloth is preferably steamed on a steam table, which are known in the art, to flatten the cloth so that the cloth can be laid flat and providing aesthetic appeal. Some curling of the edges of the cloth may occur without this step, however, the functional advantages of the cloth will be the same with or without steaming.

In use, the cloth according to the invention can be used as a wash cloth or formed as a glove or mift for the hand. The cloth can also be attached to a preferred personal care device such as a back scrubber, or a sponge, or as an accessory to like devices. The cloth according to the preferred embodiment of the invention is also resilient because the fabric stretches and resiliently retains its original shape. Further, the cloth has the advantage of being soft to the touch, and lathers voluminously because of the preferred yarn qualities specified above.

It will occur to those of ordinary skill that various modifications may be made to the disclosed embodiments. The disclosed embodiments are given by way of illustration and not limitation. The scope of the invention is intended to be defined by the appended claims.

1. A skin care device for personal cleaning of a person's body, which comprises:
a knitted cloth of synthetic fabric;
the synthetic fabric comprises a plurality of synthetic ply yarn strands which are twisted in the range of about 6.0 twists per inch to 6.39 twists per inch;
the plurality of synthetic ply yarn strands include a plurality of synthetic single yarn threads each being twisted in the range of about 8.85 twists per inch to 9.39 twists per inch;
the plurality of synthetic single yarn threads include a plurality of spun synthetic elongated fibers, the plurality of spun synthetic elongated fibers have a diameter in the range of about 2.8 dTex to 3.4 dTex;
the knitted cloth includes stitching comprising the plurality of synthetic ply yarn strands, the stitching is about 8 to 12 stitches per inch along a length of the cloth and about 3 to 7 stitches per inch along a width of the cloth; and
the knitted cloth defines a plurality of edges which are finished using a stitching arrangement of a yarn material to bind the edges of the cloth.

2. The skin care device of claim 1 wherein the plurality of synthetic ply yarn strands are substantially acrylic.

3. The skin care device of claim 1 wherein the fiber size of the plurality of spun synthetic elongated fibers is about 3.1 dTex.

4. The skin care device of claim 1 wherein the plurality of synthetic single yarn threads are twisted about 9.12 twists per inch.

5. The skin care device of claim 1 wherein the plurality of synthetic ply yarn strands are twisted about 6.20 twists per inch.

6. The skin care device of claim 1 wherein the stitching is about 10 stitches per inch along the length of the cloth and 5 stitches per inch along the width of the cloth.

7. The skin care device of claim 1 wherein the plurality of synthetic ply yarn strands comprise two synthetic single yarn threads.

8. The skin care device of claim 2 wherein the yarn material is different than the acrylic ply yarn.

9. The skin care device of claim 1 wherein the yarn material is substantially acrylic ply yarn.

10. The skin care device of claim 1 wherein the stitching arrangement of the knitted cloth includes marrowing and crocheting.

11. The skin care device of claim 1 wherein the stitching arrangement of the knitted cloth includes a stitch pattern having areas of raised stitching.

12. The skin care device of claim 2 wherein the plurality of acrylic ply yarn strands are high bulk acrylic ply yarn.

13. The skin care device of claim 1 wherein a portion of the edges of the knitted cloth are bound to each other to define a cavity and an opening communicating with the cavity, and the cavity and opening are both adapted to accept a person's hand.

14. The skin care device of claim 1 wherein the knitted cloth is coupled to a holding device selected from the group consisting essentially of a pad, a brush, and a sponge.

15. The skin care device of claim 1 wherein the plurality of synthetic single yarn threads are “Z” twisted and the plurality of synthetic ply yarn strands are “S” twisted.

16. The skin care device of claim 1 wherein the plurality of spun synthetic elongated fibers are 3 denier semi dull Acrylic.

17. A method of manufacturing a skin care device for use on a person's body, comprising:
providing a plurality of elongated synthetic fibers having diameters in the range of about 2.8 dTex to 3.4 dTex;
spinning the plurality of elongated synthetic fibers into a plurality of synthetic single yarn threads being twisted from the spinning in the range of about 8.85 twists per inch to 9.39 twists per inch;
twisting at least two of the plurality of synthetic single yarn threads together to provide a plurality of synthetic yarn strands twisted in the range of about 6.0 twists per inch to 6.39 twists per inch;
knitting the plurality of synthetic yarn strands into a cloth having about 10 stitches per inch along a length and 5 stitches per inch along a width of the cloth; and
finishing a plurality of edges defined by the cloth to bind the plurality of edges.

18. The method of claim 17 wherein the step of finishing the plurality of edges includes:
marrowing the edges; and
crocheting the edges.

19. The method of claim 17 wherein the plurality of elongated synthetic fibers are substantially acrylic.

20. The method of claim 17 wherein the diameters of the plurality of elongated synthetic fibers are about 3.1 dTex, the plurality of synthetic single yarn threads are twisted about 9.12 twists per inch, and the plurality of synthetic yarn strands are twisted about 6.20 twists per inch.
